(19) United States
(12) Patent Application Publication
(10) Pub. No.: US 2025/0363144 A1
(43) Pub. Date: Nov. 27, 2025

(54) SYSTEM AND METHOD FOR PREDICTING IMPACT ON CONSUMER SPENDING USING MACHINE LEARNING

(71) Applicant: VERDE GROUP INC., TORONTO (CA)

(72) Inventors: Paula COURTNEY, North York (CA); Jon SKINNER, Louisville, CO (US)

(21) Appl. No.: 19/294,882

(22) Filed: Aug. 8, 2025

Related U.S. Application Data
(63) Continuation-in-part of application No. 17/984,977, filed on Nov. 10, 2022.
(60) Provisional application No. 63/279,863, filed on Nov. 16, 2021.

(51) Int. Cl. G06F 16/3329; G06F 40/30; G06Q 30/0201

(52) U.S. Cl. CPC G06F 16/3329; G06F 40/30; G06Q 30/0201

(57) ABSTRACT

Systems and methods are provided for analyzing unstructured data to generate problem statements using retrieval-augmented generation techniques. Unstructured data representative of customer experiences may be obtained and analyzed to generate problem statements using a large language model augmented by a historical problem statement data set. Generated problem statements may include one or more attributes, including an identification of the source quotation from the unstructured data used as the basis for the generated problem statement. Generated problem statements may further include attributes indicating severity. The historical problem statement data set may be updated to include additional generated problem statements.

### CROSS-REFERENCE TO RELATED APPLICATIONS

This patent application claims the priority to and benefit of U.S. Provisional Patent Application No. 63/279,863, filed on Nov. 16, 2021, and U.S. patent application Ser. No. 17/984,977, filed Nov. 10, 2022, the entire contents of each of the above-identified applications being incorporated herein by reference.

### FIELD

The present disclosure generally relates to the field of computer processing and machine learning. More specifically, the present disclosure relates to processing various forms of unstructured feedback data to predict a financial impact using artificial intelligence and machine learning techniques.

### BACKGROUND

Customers, including other businesses in B2B transactions, may visit various stores, including both physical brick and mortar stores and online stores, to purchase products and services. Some vendors may experience a positive or negative financial impact when a customer encounters certain types of experiences.

Customer feedback may be collected in various forms, either in person, on the telephone, and/or online, after the customer has completed a shopping trip or experience. However, collected data is often unstructured and/or too voluminous to facilitate efficient analysis or generation of actionable insights.

### SUMMARY

In accordance with an aspect, there is provided a computer-implemented system for computing economic impact of customer experiences. The system includes a communication interface, at least one processor, memory in communication with the at least one processor, and software code stored in the memory. The software code, when executed at the at least one processor causes the system to: maintain a data set including a plurality of types of negative customer experiences; maintain a tree model for predicting economic impact of one or more of the plurality of types of negative customer experiences; receive feedback data reflective of customer experiences; generate a decision tree based on the tree model, the data set and the feedback data, the decision tree having a plurality of internal nodes with each internal node corresponding to a type of the plurality of types of negative customer experiences; compute economic impact of at least one of the types of negative customer experiences using the generated decision tree and the feedback data; and cause to render, at a display screen, a graphic user interface visualizing the computed economic impact of at least one of the types of negative customer experiences.

In some embodiments, the tree model is a classification and regression tree (CART) model and the decision tree is a binary tree.

In some embodiments, the binary tree is generated using machine learning.

In some embodiments, each leaf of the decision tree comprises a class label indicating a classification of a type of negative customer experience corresponding to a given internal node of the decision tree.

In some embodiments, the class label comprises a real value between 0 and 1, and a value equal to or greater than 0.5 indicates that the associated type of negative customer experience has a meaningful economical impact.

In some embodiments, generating the binary tree may include: splitting the data set comprising the plurality of types of negative customer experiences into two groups based on a first cost function; and for each of the two groups: splitting the types of negative customer experiences in each respective group into two subsets based on a second cost function; and iteratively splitting the types of negative customer experiences in each respective subset into further binary subsets using a recursive binary splitting procedure until a predetermined threshold is reached.

In some embodiments, the predetermined threshold is a count on a total number of training instances assigned to each internal node of the binary tree.

In some embodiments, splitting the types of negative customer experiences includes selecting one type from the types of negative customer experiences and setting the selected type as an internal node.

In some embodiments, the feedback data may include a loyalty status, and the economic impact is computed based on said loyalty status.

In some embodiments, the software code, when executed at said at least one processor, causes said system to compute the economic impact of at least one of the types of negative customer experiences by: computing, for the at least one type of negative customer experience, a frequency of occurrence among a plurality of customers based on the feedback data; computing, for the at least one type of negative customer experience, a financial impact on the plurality of customers based on the feedback data; and determining the economic impact of for the at least one type of negative customer experience by multiplying the frequency of occurrence by the financial impact.

In some embodiments, computing the financial impact for the at least one type of negative customer experience on the plurality of customers based on the feedback data may include: determining, based on the feedback data, a first average amount of spending among a first group of customers that did not experience the at least one type of negative customer experience, the first group of customers from the plurality of customers; determining, based on the feedback data, a second average amount of spending among a second group of customers that experienced the at least one type of negative customer experience, the second group of customers from the plurality of customers; and computing the financial impact based on a difference between the first average amount of spending and the second average amount of spending.

In accordance with another aspect, there is provided a computer-implemented method for computing economic impact of customer experiences. The method may include: maintaining a data set including a plurality of types of negative customer experiences; maintaining a tree model for predicting economic impact of one or more of the plurality of types of negative customer experiences; receiving feedback data reflective of customer experiences; generating a decision tree based on the tree model, the data set and the feedback data, the decision tree having a plurality of internal nodes with each internal node corresponding to a type of the plurality of types of negative customer experiences; computing economic impact of at least one of the types of negative customer experiences using the generated decision tree and the feedback data; and causing to render, at a display screen, a graphic user interface visualizing the computed economic impact of at least one of the types of negative customer experiences.

In some embodiments, the tree model is a classification and regression tree (CART) model and the decision tree is a binary tree.

In some embodiments, the binary tree is generated using machine learning.

In some embodiments, each leaf of the decision tree comprises a class label indicating a classification of a type of negative customer experience corresponding to a given internal node of the decision tree.

In some embodiments, the class label comprises a real value between 0 and 1, and a value equal to or greater than 0.5 indicates that the associated type of negative customer experience has a meaningful economical impact.

In some embodiments, generating the binary tree may include: splitting the data set comprising the plurality of types of negative customer experiences into two groups based on a first cost function; and for each of the two groups: splitting the types of negative customer experiences in each respective group into two subsets based on a second cost function; and iteratively splitting the types of negative customer experiences in each respective subset into further binary subsets using a recursive binary splitting procedure until a predetermined threshold is reached.

In some embodiments, the predetermined threshold is a count on a total number of training instances assigned to each internal node of the binary tree.

In some embodiments, splitting the types of negative customer experiences includes selecting one type from the types of negative customer experiences and setting the selected type as an internal node.

In some embodiments, computing the economic impact of at least one of the types of negative customer experiences may include: computing, for the at least one type of negative customer experience, a frequency of occurrence among a plurality of customers based on the feedback data; computing, for the at least one type of negative customer experience, a financial impact on the plurality of customers based on the feedback data; and determining the economic impact of for the at least one type of negative customer experience by multiplying the frequency of occurrence by the financial impact.

In some embodiments, computing the financial impact for the at least one type of negative customer experience on the plurality of customers based on the feedback data may include: determining, based on the feedback data, a first average amount of spending among a first group of customers that did not experience the at least one type of negative customer experience, the first group of customers from the plurality of customers; determining, based on the feedback data, a second average amount of spending among a second group of customers that experienced the at least one type of negative customer experience, the second group of customers from the plurality of customers; and computing the financial impact based on a difference between the first average amount of spending and the second average amount of spending.

In accordance with yet another aspect, there is provided a non-transitory computer-readable storage medium storing instructions. The instructions, when executed, adapt at least one computing device to: maintain a data set including a plurality of types of negative customer experiences; maintain a tree model for predicting economic impact of one or more of the plurality of types of negative customer experiences; receive feedback data reflective of customer experiences; generate a decision tree based on the tree model, the data set and the feedback data, the decision tree having a plurality of internal nodes with each internal node corresponding to a type of the plurality of types of negative customer experiences; compute economic impact of at least one of the types of negative customer experiences using the generated decision tree and the feedback data; and cause to render, at a display screen, a graphic user interface visualizing the computed economic impact of at least one of the types of negative customer experiences.

In some embodiments, the tree model is a classification and regression tree (CART) model and the decision tree is a binary tree.

In some embodiments, the binary tree is generated using machine learning.

In some embodiments, each leaf of the decision tree comprises a class label indicating a classification of a type of negative customer experience corresponding to a given internal node of the decision tree.

In some embodiments, the class label comprises a real value between 0 and 1, and a value equal to or greater than 0.5 indicates that the associated type of negative customer experience has a meaningful economical impact.

In some embodiments, generating the binary tree may include: splitting the data set comprising the plurality of types of negative customer experiences into two groups based on a first cost function; and for each of the two groups: splitting the types of negative customer experiences in each respective group into two subsets based on a second cost function; and iteratively splitting the types of negative customer experiences in each respective subset into further binary subsets using a recursive binary splitting procedure until a predetermined threshold is reached.

In some embodiments, the predetermined threshold is a count on a total number of training instances assigned to each internal node of the binary tree.

In some embodiments, splitting the types of negative customer experiences includes selecting one type from the types of negative customer experiences and setting the selected type as an internal node.

In some embodiments, the instructions, when executed, adapt at least one computing device to: compute, for the at least one type of negative customer experience, a frequency of occurrence among a plurality of customers based on the feedback data; compute, for the at least one type of negative customer experience, a financial impact on the plurality of customers based on the feedback data; and determine the economic impact of for the at least one type of negative customer experience by multiplying the frequency of occurrence by the financial impact.

In some embodiments, computing the financial impact for the at least one type of negative customer experience on the plurality of customers based on the feedback data may include: determining, based on the feedback data, a first average amount of spending among a first group of customers that did not experience the at least one type of negative customer experience, the first group of customers from the plurality of customers; determining, based on the feedback data, a second average amount of spending among a second group of customers that experienced the at least one type of negative customer experience, the second group of customers from the plurality of customers; and computing the financial impact based on a difference between the first average amount of spending and the second average amount of spending.

In accordance with still another aspect, there is provided a computer-implemented method for analyzing unstructured data representative of customer experiences, the method comprising: maintaining a historical problem statement data set including a plurality of text strings identifying problem statements associated with customer experiences; obtaining an input data set comprising unstructured data representative of customer experiences; and generating, based on a large language model (LLM) and said historical problem statement data set, an output data set comprising one or more generated problem statements.

In accordance with still another aspect, there is provided a non-transitory computer-readable medium having stored thereon computer-readable instructions that, when executed by one or more processors, cause the one or more processors to perform a method comprising: maintaining a historical problem statement data set including a plurality of text strings identifying problem statements associated with customer experiences; obtaining an input data set comprising unstructured data representative of customer experiences; and generating, based on a large language model (LLM) and said historical problem statement data set, an output data set comprising one or more generated problem statements.

In accordance with still another aspect, there is provided a computer-implemented system for analyzing unstructured data representative of customer experiences, the system comprising: at least one processor; a non-transitory computer-readable medium having stored thereon processor-executable instructions that, when executed by said at least one processor, cause the at least one processor to perform a method comprising: maintaining a historical problem statement data set including a plurality of text strings identifying problem statements associated with customer experiences; obtaining an input data set comprising unstructured data representative of customer experiences; and generating, based on a large language model (LLM) and said historical problem statement data set, an output data set comprising one or more generated problem statements.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### BRIEF DESCRIPTION OF THE FIGURES

In the Figures, which illustrate example embodiments,

FIG. 1 is a schematic diagram of a computer-implemented system for computing economic impact of customer experiences, in accordance with an embodiment.

FIG. 2 is an example flowchart for computing economic impact of customer experiences, in accordance with an embodiment.

FIG. 3 shows an example list of potential negative experiences customers can encounter at a physical store, in accordance with an embodiment.

FIG. 4 is an example graphical user interface (GUI) displaying an average revenue at risk per customer, in accordance with an embodiment.

FIG. 5 is an example graphical user interface (GUI) displaying an average annual revenue at risk per customer and a list of locations with the highest risk or lowest risk, in accordance with an embodiment.

FIG. 6 is an example graphical user interface (GUI) displaying an average revenue at risk per customer grouped by demographic and household income, in accordance with an embodiment.

FIG. 7 shows an example process for computing economic impact of customer experiences performed by the system in FIG. 1, in accordance with an embodiment.

FIGS. 8A to 8G each show aspects of an example survey that can be presented to customers, in accordance with an embodiment.

FIG. 9 depicts a block diagram of an example system for analyzing unstructured data to generate problem statements using retrieval-augmented generation, in accordance with some embodiments.

### DETAILED DESCRIPTION

The present disclosure provides a computational system and method for processing unstructured data, and isolating and quantifying the financial impact of sub-optimal or negative customer experiences. The system may be configured to receive a large volume and variety of data elements including customer experiences and customer spending data, and through an automated (e.g., via machine learning) process of measurement and analysis, generates actionable insights defining the relationship between a company's financial performance and a the customer feedback. The system may also automatically identify issues with the largest detrimental impact on customer experience. The system may also aggregate the findings and present one or more GUI elements to efficiently and intelligently display the customer issues affecting a financial performance of a company, with convenient and data-efficient indications as to the economical impact of each relevant customer issue.

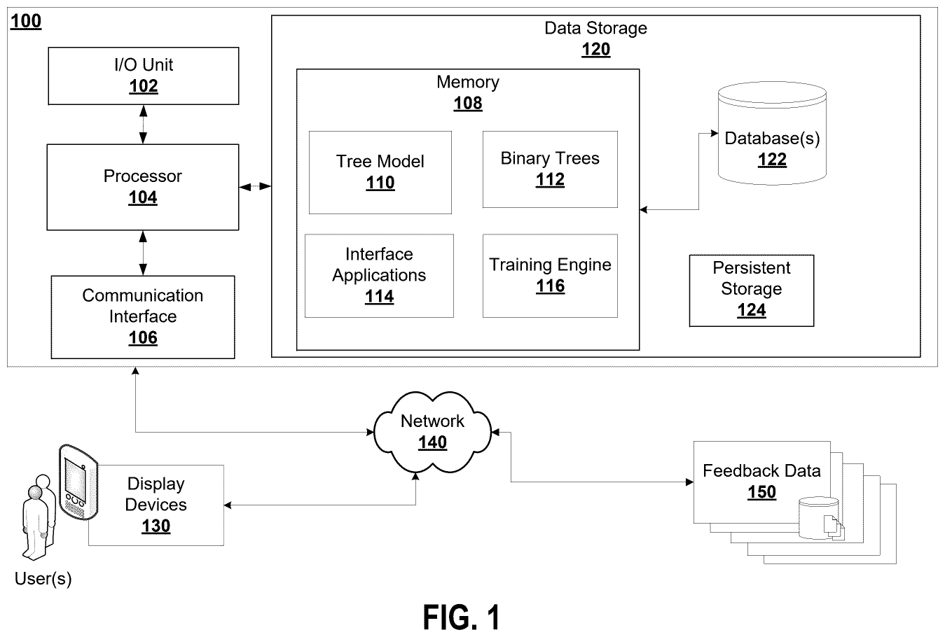

FIG. 1 is a high-level schematic diagram of an example computer-implemented system 100 for computing economic impact of customer experiences, in accordance with some embodiments. As depicted, system 100 has data storage 120 including a memory 108 and a persistent storage 124. The memory 108 and/or the persistent storage 124 may store one or more databases 122. The databases 122 may store one or more data sets, including a plurality of types of negative customer experiences, and customer feedback data regarding experiences. The data sets include, in some embodiments, a portfolio of hundreds (or more) of experiences for customers, who encounter these experiences in the course of their relationship with the company, e.g., at their physical store locations.

The system 100 can also include an I/O unit 102, a processor 104, and a communication interface 106. The I/O unit 102 can enable the system 100 to interconnect with one or more input devices, such as a keyboard, mouse, camera, touch screen and a microphone, and/or with one or more output devices such as a display screen and a speaker.

The processor 104 is configured to execute machine-executable instructions to implement the processes disclosed herein such as, for example, generate a decision tree based at least on the data set stored in 122 in order to compute economic impact of customer experiences. Further, the processor 104 can execute instructions in memory 108 to implement aspects of processes described herein. Further, the processor 104 can execute instructions in memory 108 to configure a tree model 110, one or more generated binary trees 112, an interface application 114 which can provide control commands to display various GUI elements at display devices 130, a training engine 116 for generating the binary tree 112, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

The persistent storage 124 may be configured to store information associated with or created by the components in memory 108 and may also include machine executable instructions. The persistent storage 124 which may include various types of storage technologies, such as solid state drives, hard disk drives, flash memory, and may be stored in various formats, such as relational databases, non-relational databases, flat files, spreadsheets, extended markup files, etc.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

The memory 108 may include an interface application 114 to process the input data from the databases 122. In some embodiments, the interface application 114 can normalize input data from the databases 122 to generating decision tree(s) 112 in manners disclosed herein

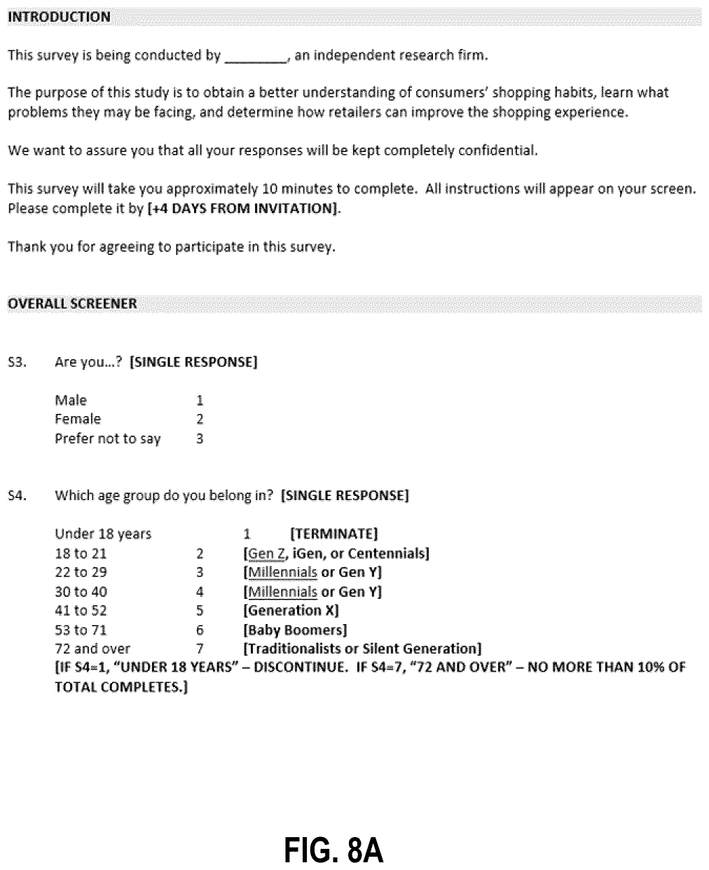

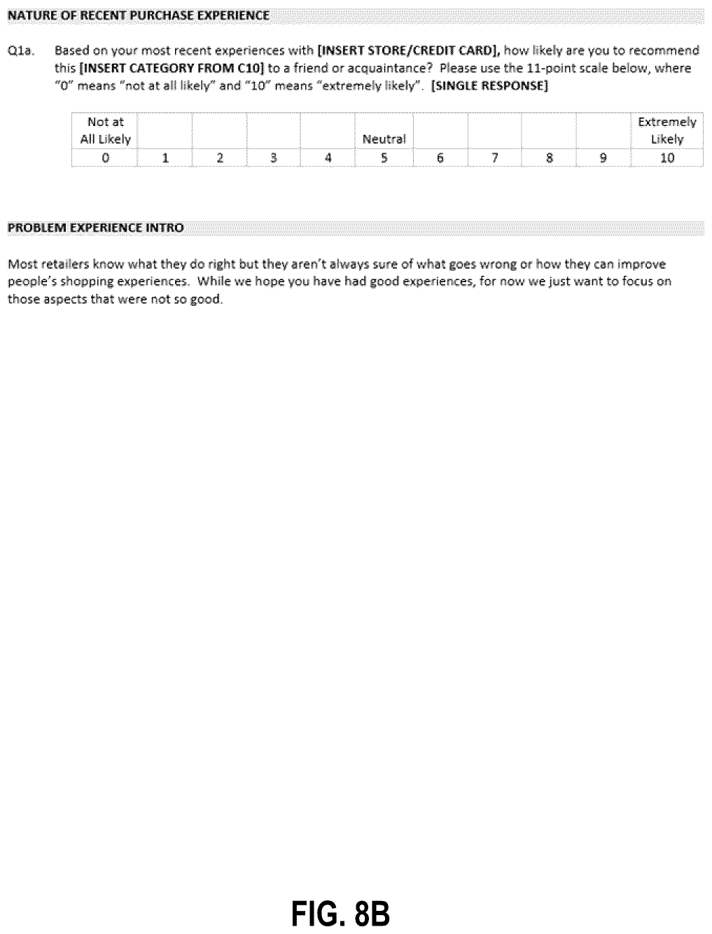

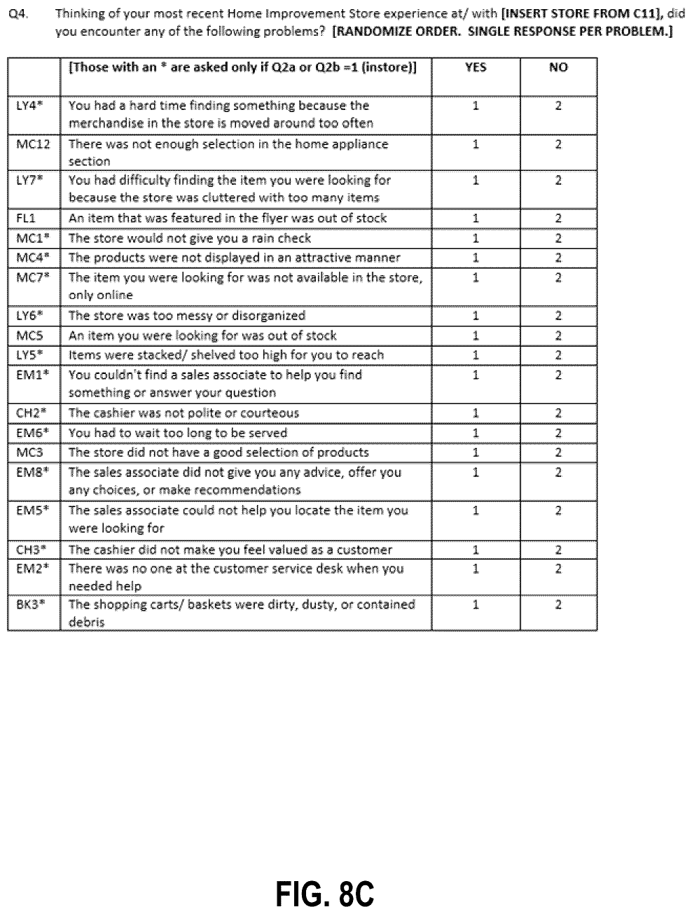

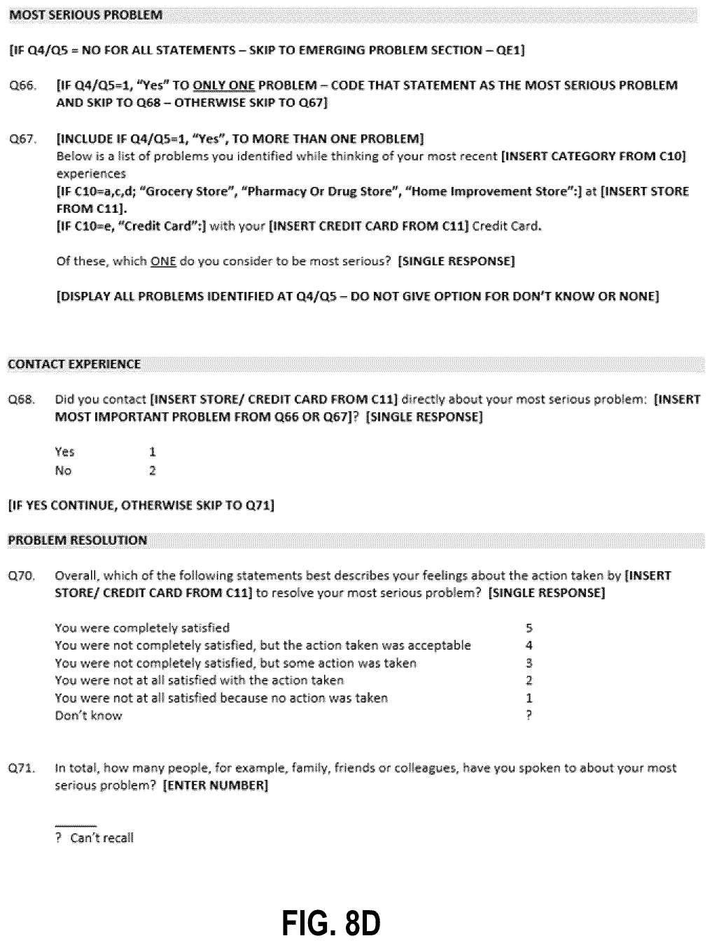

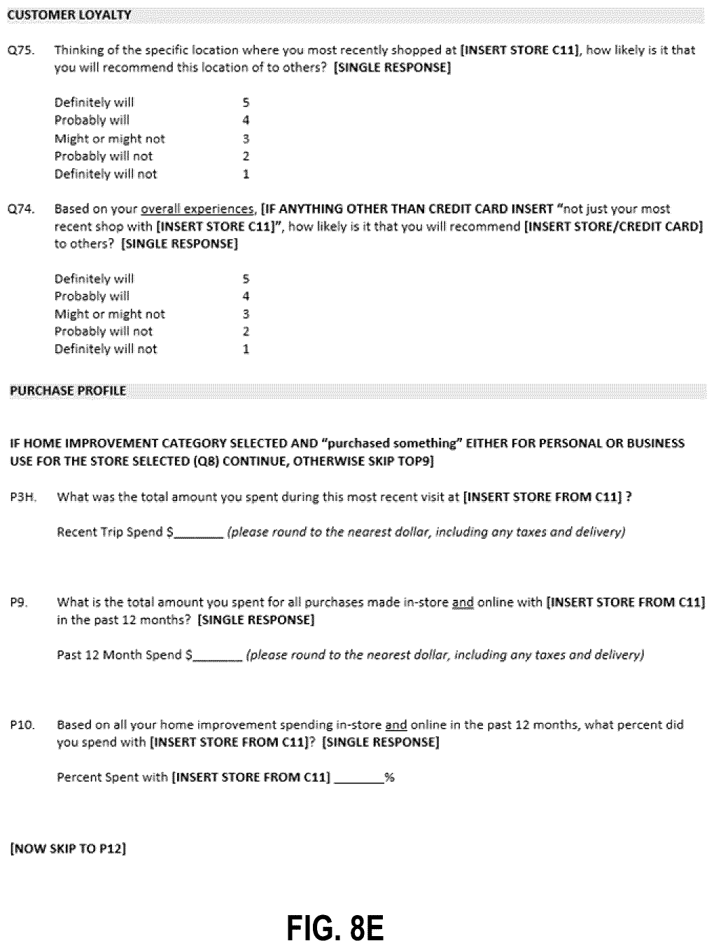

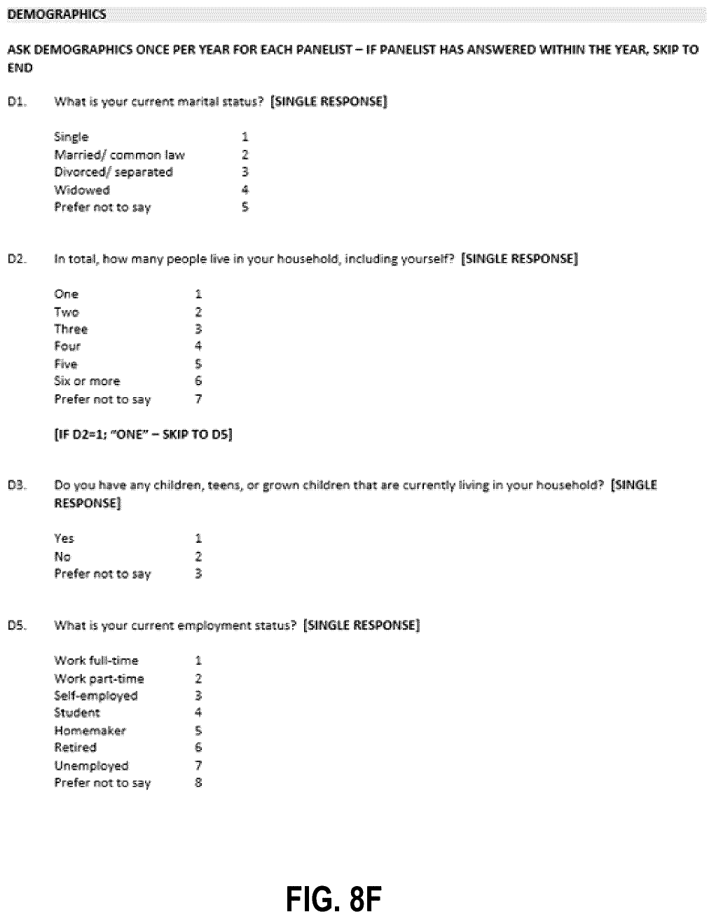

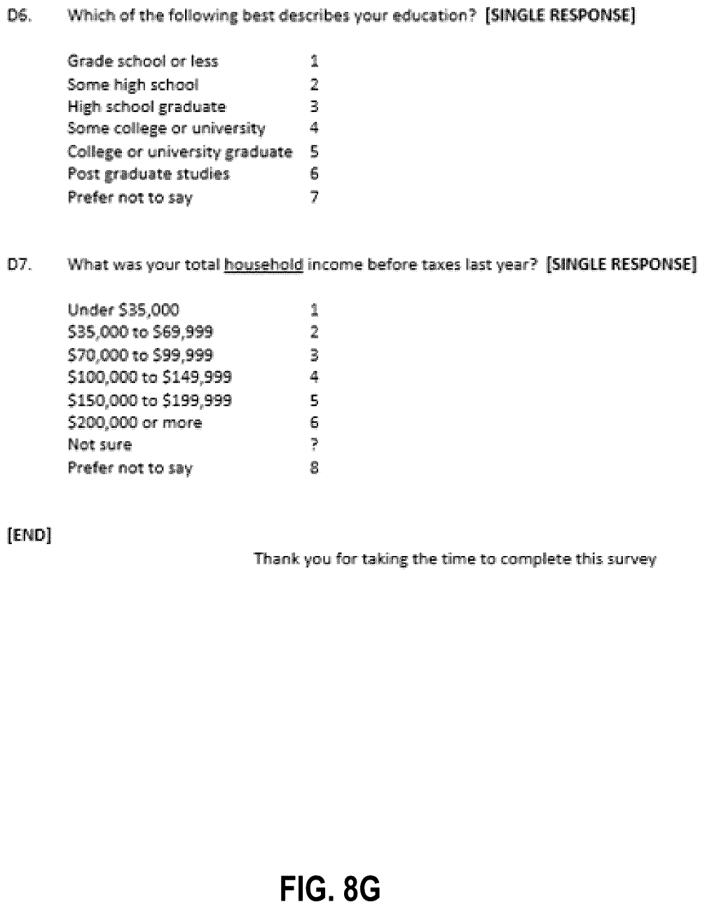

The memory 108 can include a tree model 110, which may include a binary tree model, for example. The tree model 110 may include a classification and regression tree (CART) model. The tree model 110 may be used to generate the decision tree for computing the economic impact of customer experiences based on feedback data 150 received via network 140. FIGS. 8A to 8G show an example survey that can be given to by one or more customers for completion. For example, the survey can be electronically presented to the one or more customers at their display devices 130. The answers from the survey completed by the customers may be processed and stored as the feedback data 150, which may be used to generate the decision tree 112.

The decision tree 112 may include a plurality of internal nodes with each internal node corresponding to a type of the plurality of types of negative customer experiences. An internal node may refer to a node that has child node(s).

In some embodiments, each leaf (or leaf node) of the decision tree may include a class label indicating a classification of a type of negative customer experience corresponding to a given internal node of the decision tree, which may be the parent node of the leaf. For example, the class label may has a real value between 0 and 1, where a value equal to or greater than 0.5 indicates that the associated type of negative customer experience has a meaningful economical impact. A meaningful economical impact may indicate that the type of negative customer experience has resulted in a economical loss above a certain threshold during a period, e.g., $1,000 per week.

In some embodiments, generating the binary tree 112 includes using a machine learning system for predictive modeling. An example decision tree algorithm implements one or more classification and regression trees (CART). Using a CART algorithm, the training engine 116 may be configured to generate binary tree by selecting input variables and split points on those variables until a suitable tree is constructed. The selection of which input variable to use and the specific split can be implemented using a greedy algorithm to minimize a cost function. Typically, construction of the binary tree ends based on a predefined stopping criterion, such as a minimum number of training instances assigned to each leaf node of the tree.

In some embodiments, the binary tree 112 may be generated by: splitting a data set representing a plurality of types of negative customer experiences into two groups based on a first cost function; and for each of the two groups: splitting the types of negative customer experiences in each respective group into two subsets based on a second cost function; and iteratively splitting the types of negative customer experiences in each respective subset into further binary subsets using a recursive binary splitting procedure until a predetermined threshold is reached.

In some embodiments, the predetermined threshold is a count on a total number of training instances assigned to each internal node of the binary tree.

In some embodiments, splitting the types of negative customer experiences includes selecting one type from the types of negative customer experiences and setting the selected type as an internal node.

In some embodiments, an elastic net regression model is conducted on feedback data 150 from customers who have shopped at one or more stores, which may be physical stores or online stores, and who have reported spending less than a certain amount (e.g., $2500) during a time period (e.g., last month) on a type of products or services (e.g., groceries). This elastic net regression model may eliminate the distorting effects of outliers and isolate the impact on a customer's share of wallet when they experience a problem. An elastic net regression model selects only the subset of problems that are determined to have a meaningful impact on the share of wallet, while filtering out other problems that co-occur with the subset of problems, but on their own do not have a meaningful impact on the share of wallet. Having a meaningful impact on a customer's share of wallet generally means that the issue or problem is determined to have caused the customer (or a group of customers) to spend less at a particular store.

If a customer's share of wallet is reported to increase when he or she has reported experiencing a problem based on the feedback data 150, the financial risk, or economical impact, of that problem is set to 0. Such statistical artifacts may occur when the problem is very infrequently experienced and when there is a co-occurrence of multiple related problems. Such problems are referred to herein as “true artifacts”, where the presence of the problem is not associated with a decrease in the customer's share of wallet. When the economic impact on a customer's share of wallet caused by a particular problem is determined, the reported monthly spending of the customer can be used to calculate the economic impact of the particular problem for the retailer.

In some embodiments, system 100 may receive feedback data 150 from different data sources, e.g., different servers via a network 140. Network 140 (or multiple networks) may be capable of transmitting data and can involve wired and/or wireless connections. In some embodiments, network 140 may include different network communication technologies, standards and protocols, for example.

In some embodiments, the feedback data 150 may include a data set representing a loyalty status of a customer. For example, the feedback data 150 may include a data set indicating whether a customer is a member of a loyalty program of the company, and if so, the customer's associated level of status in the loyalty program. For example, if a loyalty program of the company has three different levels, a value of 10 may indicate the highest member tier (e.g., “diamond member”), a value of 6 may indicate the second highest level of member tier (e.g., “gold member”), a value of 3 may indicate the third highest level of member tier (e.g., “silver member”), while a level of 0 may indicate a customer who is not a member. In some embodiments, a customer's loyalty status may be a binary variable with a value of 1 or 0 to indicate a simple ‘yes’ or ‘no’, respectively, to member status within a loyalty program.

In some embodiments, the feedback 150 may include a data item or set representing a loyalty value of a customer. For example, the loyalty value may be generated based on one or more types of behavioral data of the customer. The behavioral data may include, for instance, historical transactions, contact behaviors, and/or interaction with the company through physical or digital means, such as participation in a formal loyalty program, signing up for and/or authorizing e-mail communication, leaving a positive or negative review of the company, participation in a webinar or promotional event, and so on.

In some embodiments, loyalty value may be generated based on self-reported data of the customer, which may include, for example, the customer's response(s) to surveys or questions. The response(s) may indicate the customer's willingness to recommend the company, an intent to re-purchase goods or services from the company, and/or an intent to re-visit the company, either online or in a physical store.

The communication interface 106 can enable the system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The system 100 can be operable to register and authenticate users (using a login, unique identifier, and password for example) prior to providing access to applications, a local network, network resources, other networks and network security devices. The system 100 may serve multiple users which may operate display devices 130.

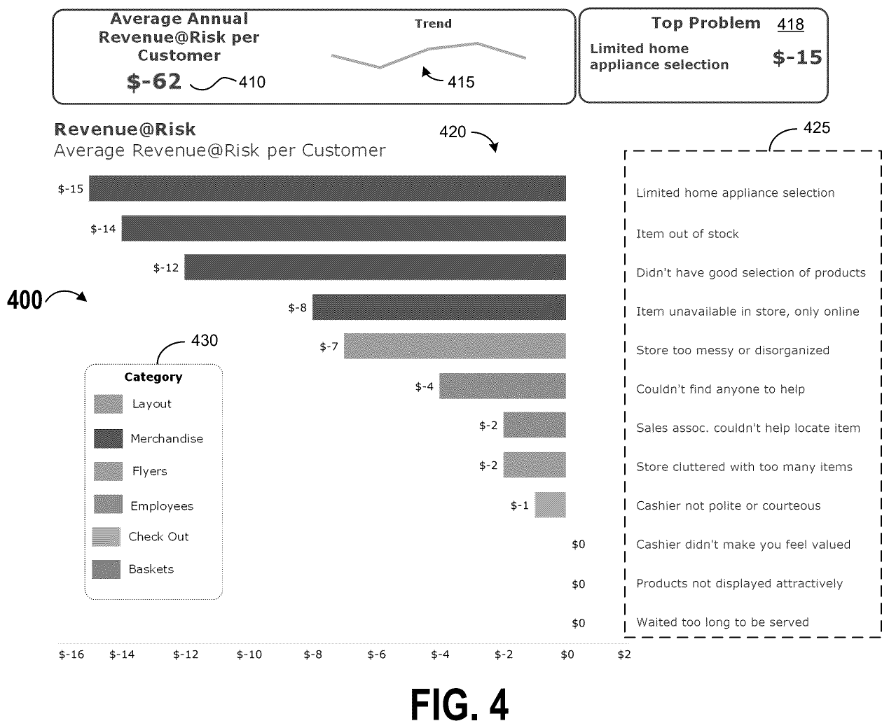

The interface application 114 interacts with the display devices 130 to exchange data (including transmission of control commands) and generates visual elements for display at user devices. The visual elements can represent output generated by the system 100, such as shown in FIGS. 4, 5 and 6.

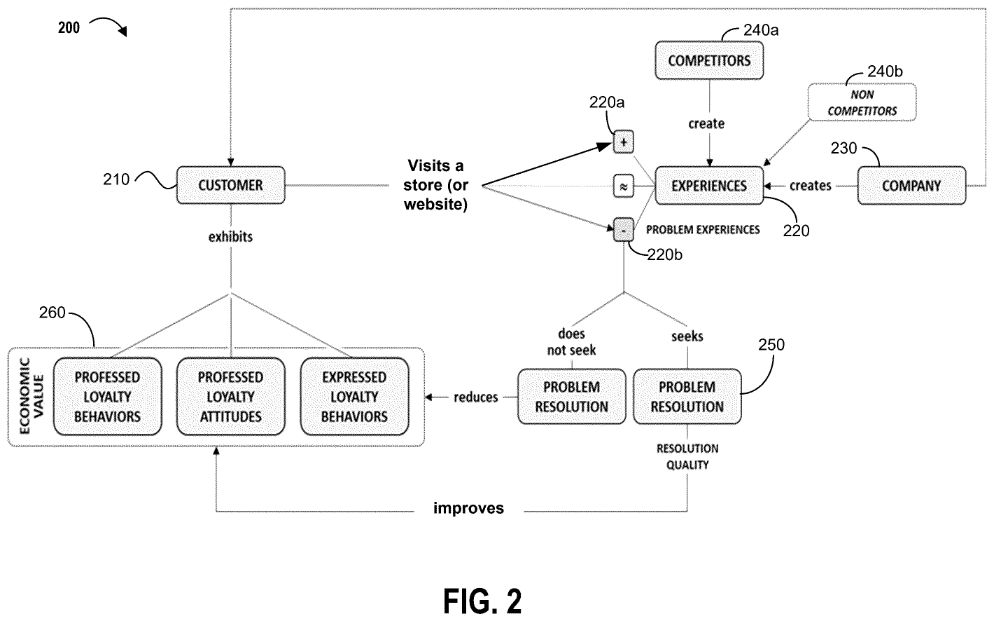

FIG. 2 is an example flowchart 200 of an example method for computing economic impact of customer experiences, exemplary of embodiments. The method depicted in flowchart 200 processes a data set including a portfolio of a plurality of experiences 220 for customers 210 who encounter these experiences in the course of their relationship with a company 230. In some embodiments, customer experience data set 220 may include hundreds, thousands or more experiences for one or more customers. Such experiences are not limited to customer experiences are at physical store locations, and may include online store experiences, as well as other contexts (e.g., experiences with call centers, and generally any context in which a customer communicates something about the particular company).

In some embodiments, experiences included in customer experience data set 220 may include positive experiences 220a, neutral experiences, and negative experiences 220b for customers. In some embodiments, the categorization of a particular experience may vary for each customer 210. Any individual customer's subjective evaluation of an experience encountered at a given company 230 (which may operate a physical or online store) may be influenced by a competitive context (e.g., can I have a better experience with a company's competitor?), and sometimes by non-competitive contexts.

As depicted, competitors 240a are companies other than the company 230 which occupy the same core market space as the company 230, and which compete for generally the same customers and/or addressable market. The competitors 240a can be an explicit data entity in the system 100, where economic implications of the performance of the company 230 are evaluated relative to the one or more competitors 240a. The competitors 240a can include single or multiple companies or brands, and also can be specific (e.g., a specific company) or general (represented collectively as a generic market alternative to the company 230).

Non-competitors 240b are companies other than the company 230 who operate in a marketspace different from the company 230, but who provide similar (possibly superior) experiences such that customers perceive the non-competitors 240b as a credible point of comparison. Non-competitors 240b can be an explicit data entity in the system 100, where the company 230 wishes to benchmark their performance against the broadest market standards available.

The system 100 includes models that focus on the economic impact of negative experiences 220b (i.e., problems), which tend to have a greater and more sustained impact on customer economic value than do neutral and positive experiences 220a. When a customer 210 experiences one or more problems with a company 230, those problems may reduce customer's economic value 260, which can be determined and represented through analysis of professed loyalty behaviors and attitudes (e.g., self-reported survey data), or directly assessed through analysis of expressed loyalty behaviors (e.g., actual customer transaction and service data.)

When customers 210 encounter problems 220b, they will either contact the company for assistance/resolution 250, or might not. When a customer 210 encounters a problem 220b and does not seek problem resolution 250, the economic value of that customer to the company is very likely to decline.

When customers 210 encounter problems 220b and do seek problem resolution 250, the customer's economic value to the company may depend on the quality of the problem resolution interaction. When the problem resolution 250 is effective, economic value may be recovered, and may sometimes exceed the original economic value pre-problem. When the problem resolution 250 is not effective, the decline in economic value may persist, and may sometimes decline beyond the initial decline.

In some embodiments, customers 210 are individuals consuming company products and services. Customer attributes are extensive, and each analysis carried out by the system 100 may be configured to address those attributes most critical to accuracy and utility of the analysis in question. A partial list of typical customer attributes for an example analysis carried out by the system 100 may include one or more of:
Spending level (e.g., $600 a month on groceries)
Product or service penetration
Tenure
Role (if a business-to-business “B2B” study)
Region/location
Demographics
Size of company they represent (if a B2B study)
Recent date of interaction
Channel
Psychographic segmentation (for clients with a pre-establish segmentation schema)
Company/Competitor (for competitive studies)
Whether the customer is problem-free or problem-afflicted. This attribute value may be a result of analysis carried out by the system 100.
Whether a customer is a contactor or non-contactor when problem-afflicted.
Loyalty and equity levels. This attribute value may be a result of analysis carried out by the system 100.

Analysis carried out by the system 100 can quantify the overall economic impact of problem experiences on customer economic value, or by any sub-segment of customers described by one or more of the above attributes. The functionality to isolate the customer classes most prone to economic value loss from problems is a core driver of the utility and actionability of insights generated by the system 100.

Experiences 220 represent interactions and events between a company 230 and its customers 210. Experiences 220 can be things that have happened (presence experiences) or things that have not happened (absence experiences). Experiences 220 can be positive, neutral or negative, the determination of which can depend on the customer's subjective interpretation of the experience 220, and which, accordingly, may vary by customer.

In some embodiments, analysis carried out by the system 100 may be carried out based on a loyalty status of one or more customers. For example, experiences 220 can include a data set representing whether a customer is a member of a loyalty program of company 230. The data set may further include a specific level of the loyalty status of the customer within the loyalty program. The higher the level of the loyalty status, the more likely the customer's economic value is higher for company 230. In addition, the analysis carried out by the system 100 may include other, different proxies for computing an economic impact of one or more customers.

In some embodiments, analysis carried out by the system 100 may be carried out based on one or more types of behavioral data of the customer. For example, experiences 220 can include customer behavioral data such as historical transactions, contact behaviors, and/or interaction with the company through physical or digital means. For example, interaction with the company may include participation in a formal loyalty program, signing up for e-mail communication, leaving a review of the company in an online channel, participation in a webinar or promotional event, and so on.

In some embodiments, experiences 220 can include self-reported data of the customer, which may include, for example, the customer's response(s) to surveys or questions. In some embodiments, the responses may indicate the customer's willingness to recommend the company, an intent to re-purchase goods or services from the company, and/or an intent to re-visit the company, either online or in a physical store.

In some embodiments, analysis carried out by the system 100 may focus on negative experiences 220b or problems, where the economic impact is expected to be the most significant. Problem attributes may include, for example:
Issue category (e.g. purchase process, account setup, training, product performance, customer service, etc.)
Customer role (different roles create different experiences, leading to role-distinct problems)
Product (different products impose different problems on customers)
Channel (different channels impose different problems on customers)
Relevance, or whether a given experience matters to economic performance in context of the relevance all other customer problems. This may be determined or derived by the system 100.
Frequency. This attribute value may be a result of analysis carried out by the system 100.
Absolute impact on economic value. This attribute value may be a result of analysis carried out by the system 100.
Word of mouth dissemination. This attribute value may be a result of analysis carried out by the system 100.

Problem resolution 250 can be defined as the act of a customer 210 proactively reaching out to a company 230 for assistance in addressing an issue, and the company 230 interacting with the customer 210 to provide assistance. Efficacy of problem resolution 250 is a critical factor in the recovery and preservation of customer economic value after the occurrence of a problem. In some embodiments, problem resolution attributes can include:
Agency. What roles within the company 230 work with the customer 210 to address the issue?
Channel. What channels does the customer 210 use to address the issue?
Effort. How much effort does the customer 210 need to exert to address the issue?
Time. How long does it take for the issue to be addressed?
Overall Efficacy. How satisfied is the customer 210 with problem resolution performance overall?
Agent Dimensional Efficacy. How satisfied is the customer 210 with specific performance attributes of the resolving agent, including Concern, Urgency, Follow Through, Follow Up, Knowledge and Authority.

Economic value markers 260 are indicators of customer equity and loyalty that directly link to customer economic value. In some embodiments, economic value markers 260 may be expressed by the customer either through a explicit opinions provided (“professed”) or through actual observed consumption behavior (“expressed”). In some embodiments, analysis carried out by the system 100 can accommodate a wide range of customer economic value markers 260 as a “dependent variable” (i.e., as an aspect of customer value the analysis seeks to explain through problem experience quantification). Economic value markers 260 may be selected to support the analytic objectives of a given analysis to be carried out by the system 100, tailored to the circumstances of a particular company and the availability of internal customer data.

In general, economic value markers 260 may fall into one of three sub-categories:
Professed Loyalty Behaviors. These may include customer self-reported behaviors (e.g., sourced from survey responses, transcripts of conversations with customers, customer reviews, call center responses, and generally any circumstance where a customer expresses an opinion about the company) that indicate future economic behavior. These behaviors can include likelihood to recommend, future spending intent (more/same/less), and trial likelihood. In the absence of adequate customer-level transaction or service data, these markers can be associated to general economic performance of the customer base to impute economic impact.
Professed Loyalty Attitudes. These are customer self-reported attitudes that may precede and shape professed and expressed loyalty behaviors. These attitudes can include trust in the company, trust in account representation, ease of doing business with the company, and belief that working with the company demonstrably improves the customer's business (in B2B environments.) These markers create explanatory context for both professed and expressed loyalty behaviors.
Expressed Loyalty Behaviors. When customer-level transaction and service data is available, the system 100 can utilize that data to directly assess the impact of problem experience and problem resolution on actual (vs. imputed) customer economic value. This attributes of this data can be extensive, and may include, for example:
   Total spend
   Spend velocity
   Share-of-spend
   Customer LTV
   Product-level spend
   Service Costs

### Quantitative Measurement

Conducting an analysis via the system 100 may include a direct solicitation of customer experiences, for example through presentation of a survey (see for example FIGS. 8A to 8G). In some embodiments, system 100 is configured to examine and document customer experience using unique and specifically designed techniques to generate efficient, accurate and comprehensive quantification of problem experiences on customer economic value.

Traditional customer surveys often ask respondents whether they had any problem. When the answer is “yes” the survey may then request verbatim detail on what the problem was, and may ask the respondent to assess the impact of the problem on their loyalty attitudes or behaviors. This traditional process typically yields inaccurate data and leads to inaccurate analysis for the following reasons:
materially underestimating the frequency of problems occurring in a customer set;
failing to create a comprehensive and accurate mapping of the majority of problems occurring in a customer set;
relying on customer “top-of-mind” problem recall, which generally skews towards the most recent problem experienced, rather than the problem most damaging to customer economic behaviors;
relying on customer's subjective self-evaluation of whether a problem is material to the customer's economic behaviors, which may introduce significant cognitive bias into the data set;
producing unstructured data (e.g., data in the form of verbatim transcripts) for analysis. Such unstructured data may be challenging to accurately assess for economic impact, and requires material effort to classify and prepare for analysis. Moreover, manual external data manipulation by human operators to work with unstructured data is generally time-consuming and resource-intensive, and may create additional opportunities for additional sources of bias and human error to enter the data set.

In some embodiments, the measurement approach undertaken by the system 100 disclosed herein may resolve the shortcomings of conventional problem assessment methods by: presenting an a priori inventory of problems; conducting binary problem assessments; and de-coupling problem occurrence from problem importance. In some embodiments, the resulting data may be structured data, which is facilitates processing.

In some embodiments, the system 100 may present an a priori inventory of problems. For example, instead of asking a customer to recollect any problem and then describe it, the system 100 can provide a highly-curated list of potential problem experiences 220b for the respondent to consider and select from, where the selection indicates that the problem occurred for the customer within a stated time frame.

In some embodiments, the list of problem experiences (also referred to herein as a list of ‘problem statements’) may be developed through a rigorous qualitative assessment of customer experiences. In some embodiments, the development of the list of problem statements may precede the quantitative survey, and may be curated by the system 100 and a company 230 together using frequency/source analysis. The benefits of such an approach over open-inquiry methods may include, for example:
A more accurate representation of total problem frequency in the customer base;
A more accurate representation of individual problem frequency in the customer base;
Lower cognitive effort for the respondent, enabling faster problem evaluation and limiting survey fatigue (which raises both abandonment rates and response error);
Creation of a structured vs. unstructured data set, with classification of problems pre-established for analytic purposes.

In some embodiments, system 100 may be configured to generate problem statements using artificial intelligence (AI) techniques. Some embodiments described herein may leverage the use of large language models (LLMs) and retrieval-augmented generation (RAG) in order to analyze customer feedback data. For example, some embodiments of system 100 may analyze and process unstructured customer data, including but not limited to transcripts of conversations with customers, customer reviews from various sources (e.g., comment sections on company 220's website, comment sections on third party websites), transcripts from call center communications with customers, and more broadly, data from any scenario in which a customer provides an opinion or otherwise communicates something about a particular company 230. In this manner, some embodiments described herein may include numerous additional forms of customer data in addition to survey results, focus groups, and the like, which may provide more accurate and robust results.

In some embodiments, supplemental processing techniques may be implemented to facilitate the above-noted analysis. For example, an audible conversation with a customer (e.g., with a call center, at an event, or the like) may be converted to a textual transcript using conventional speech-to-text analysis engines which are now ubiquitous.

In some embodiments, LLMs (such as GPT 3.5 by OpenAI) may be used in combination with RAG techniques to analyze textual data containing customer opinions to determine problem statements. RAG is a technique in which relevant information (typically information which was not contained in the training data used to train the LLM) is provided to an LLM as additional context. For example, an LLM may be supplemented with a data set of problem statements. In so doing, the LLM is said to be ‘augmented’, and may make use of the additional context information to provide more accurate results, rather than relying solely on the training data used to train the LLM (which may be static, dated, and/or may exclude domain-specific specialist knowledge).

For example, some embodiments may be configured to accept a prompt to identity any problem statements contained within a customer feedback data object (e.g. customer reviews, call transcripts, any unstructured data where a customer has provided an opinion about the company). In response, system 100 may generate a list of problem statements.

In some embodiments, the use of Al techniques in processing textual data to identify problem statements may provide numerous advantages over conventional techniques. For example, a problem statement data set may include hundreds or even thousands of problem statements, meaning a model for generating problem statements may be trained based at least in part of the structure of previously identified and validated problem statements from previous studies. In some embodiments, the generating of problem statements from unstructured data may require a matter of seconds or minutes, rather than manual processes which may take over a week, and teams of experts to develop preliminary assessments of problems.

Thus, in contrast to conventional, labour-intensive, subject ways of attempting to define problems from unstructured data sets, some embodiments provide an automated method for identifying problems encountered by a customer. Moreover, the use or Retrieval-Augmented Generation may obviate any need to create or model an LLM, and instead allow for the use of commercially available LLMs which are augmented with the proprietary problem statement data sets.

In some embodiments, system 100 may be configured to categorize customer interactions based on whether the interaction occurred in a physical location, or online. In some embodiments, categorizations may include a category and description. In some embodiments, problem statements identified within a customer interaction may be classified based on the category.

Some embodiments employ a multi-agent orchestration architecture comprising specialized agents. In some embodiments, specialized agents may include one or more of a conversion agent for document format transformation, a metadata agent for participant identification and project metadata extraction, an analysis agent for problem statement generation, and a research agent for domain and nature classification assignment. In some embodiments, each agent may maintain persistent state information and coordinates through a centralized router agent configured to manage workflow progression through distinct processing phases. In some embodiments, distinct processing phases may include one or more of document processing, entity creation, analysis, and/or persistence.

Some embodiments described herein may generate and store vector embeddings for entities. In some embodiments, entities may include one or more of projects, categories, domains, natures, and problem statements. In some embodiments, embeddings may be generated using embedding models (such as, for example, OpenAI and/or Azure OpenAI embedding models). In some embodiments, vector similarity searches may be performed using PostgreSQL with pgvector extensions and IVF-Flat indexing for cosine similarity operations, which may enable semantic matching between user queries and stored problem statements in a historical dataset, as described below.

In some embodiments, the system may include specialized processing logic for different research methodologies. For example, some embodiments may be configured to perform distinct specialized processing for each of focus group transcripts, one-on-one interviews, and survey responses. Some embodiments may be configured to automatically identify participant roles (e.g., interviewer, moderator, facilitator, and respondent), and may be configured to apply inclusion filtering to ensure that only relevant participant statements are processed for the purposes of problem statement generation. Likewise, some embodiments may be configured to exclude facilitator contributions from analysis (e.g., through the use of an “is_included” flag mechanism).

Some embodiments described herein may maintain bi-directional linking between generated problem statements and source transcript quotations, which may include specific participation attribution. For example, when statement sources are initially unidentified, the system may be configured to employ a context resolution algorithm that analyzes surrounding document portions (or chunks) within a configurable context window to determine the appropriate participant attribution (e.g., through semantic analysis of neighbouring text sections).

As described below, some embodiments may be configured to generate structured problem statements with multiple classification dimensions. In some embodiments, classification dimensions may include category (which is project-specific), domain (which is cross-project), and nature (which describes how the problem manifests). In some embodiments, each generated problem statement may include one or more of sentiment scoring (e.g., on a 1-5 scale), contextual explanations, and source quotations which include participant attribution. In some embodiments, the system may employ validation logic to ensure problem statements originate only from included participants and/or meet quality criteria before being persistently stored in a database.

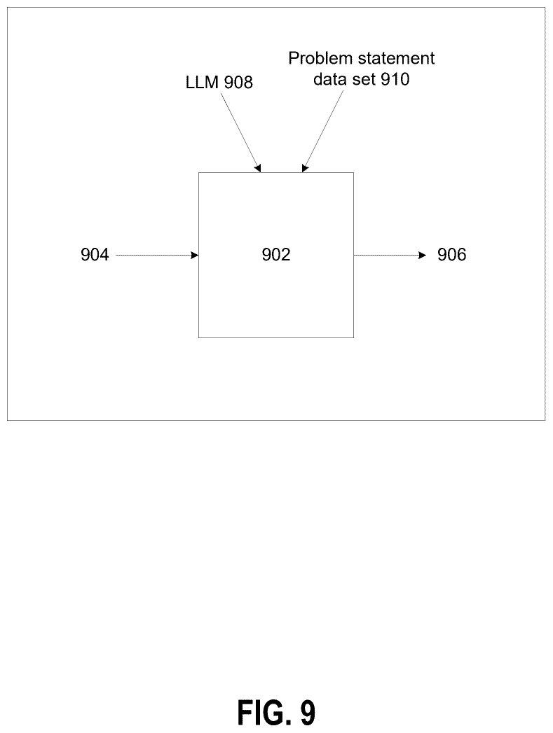

FIG. 9 depicts an example system for analyzing unstructured data and identifying problem statements using retrieval-augmented generation. As depicted, problem statement generator system 902 is configured to receive input customer interaction data 904 and generate an output problem statement data set 906. In some embodiments, output data set 906 may be a spreadsheet document. It will be appreciated that other file formats are contemplated, and that spreadsheets are merely an example data format which may be suitable in certain scenarios.

In some embodiments, input customer interaction data set 904 may be a file comprising unstructured data. For example, customer interaction data set 904 may include a transcript, or multiple different transcripts. For example, customer interaction data set 904 may include a transcript of an interview with a customer, call center logs, customer reviews, survey results, or the like.

In some embodiments, customer interaction data set 904 may be uploaded to problem statement generator system 902 (e.g., via a web interface). In some embodiments, once the transcripts have been uploaded, system 902 may begin analyzing the transcripts using an LLM 908 and RAG (using problem statement data set 910) and determine problem statements based on the contents of the uploaded transcripts.

In some embodiments, problem statement generator system 902 may generate an output problem statement data set 906 which contains one or more problem statements based on the contents of input data 904. In some embodiments, the output data set 906 may include a number of attributes in addition to the problem statements. In embodiments in which the output data set 906 is embodied as a spreadsheet, attributes may be included, for example, as separate columns (e.g., a row might contain the generated problem statement itself, and additional attributes in other columns within that row).

For example, for each identified problem statement, output data set 906 may include a citation to the source quotation from the transcript which was the basis for the identified problem statement. In some embodiments, the citation may be a link to the access the transcript itself. In some embodiments, the citation may be a textual reproduction of the quotation itself (e.g., contained within a different column of the row containing the problem statement).

In some embodiments, output data set 906 may include one or more of a category, domain, and/or nature associated with a given problem statement. Example categories may be included, but not limited to, one or more of store layout, merchandise, flyers, employees, checkout, and/or baskets.

In some embodiments, output data set 906 may include a sentiment score indicating the severity of a generated problem statement. In an example embodiment, a severity score might be a value in the range of 1 to 4, where a value of 1 indicates the most aggressively negative sentiment, and a value of 4 indicates a less severe sentiment.

In some embodiments, output data set 906 may include an attribute which indicates whether a generated problem statement has been identified as a Most Damaging Problem (as described below) in past analyses. For example, a value of ‘True’ for the MDP attribute may indicate that the problem statement has been an MDP previously, and a value of ‘False’ may indicate that the problem statement has not previously been an MDP in other analyses. In some embodiments, the MDP attribute may be a numerical value (which indicates, for example, the number of times the generated problem statement has been an MDP in previous analysis, as opposed to a yes/no flag).

As described above, problem statement generation system 902 may use LLM 908 and problem data set 910 to analyze a source quotation within input data set 902 and provide its view of what the problem was, and provide additional context as to what the source quotation really means.

In some embodiments, input data 904 may contain a plurality of transcripts. In some embodiments, system 902 may output a single output file containing generated problem statements. In other embodiments, system 902 may be configured to output separate output files for each of the plurality of transcripts contained within input data 904.

In some embodiments, problem statement generation system 902 may facilitate the automated development of survey instruments. For example, selecting the nature/topics of the questions which are included in a survey instrument might be based on one or more attributes of problem statements. For example, surveys may target problems which are any of: problems that have been identified as having the most material impact previously (e.g., the sorts of problems which have been identified as MDPs previously), problems having the highest sentiment/severity attribute value, problems from a particular domain/nature, problems which have penetration into a particular category, and the like.

In some embodiments, the knowledge of the frequency with which a problem has been an MDP previously may be used as a basis for including questions relating to that problem in a survey. As noted above, a problem statement data set may contain thousands of problem statements—some embodiments described herein provide a method of streamlining selection of problem statements for inclusion in surveys, which may render surveys more effective at gleaning relevant customer data.

Moreover, the generation of survey tools may be reduced to a matter of minutes rather than weeks, which may allow a company to quickly obtain current information from customers. The nature of business is that customer sentiment is dynamic, and an organization may be constantly in search of the most current customer data to identify current or recent problems, as opposed to problems which were an issue 6 months ago and are no longer relevant. Some embodiments described herein may allow for periodic and/or constant updating of problem statement data sets by analyzing various sources of unstructured data (e.g. customer reviews, call center logs, and the like), of which some sources may be constantly the subject of new content. For example, a company may receive hundreds of new customer reviews per day at various e-commerce websites-embodiments described herein allow for the most current information to be analyzed and harnessed to provide the most pertinent problem statements for customers at the present time.

Some embodiments described herein may facilitate periodic and/or constant generation of surveys based on up-to-date problem statement data sets, and may further allow for the analysis of responses to such surveys to take place relatively quickly. As such, some embodiments described herein may reduce the time required to formulate a survey and analyze the results from respondents to a few days rather than a few weeks or months. In this manner, some embodiments may provide significantly more pertinent and current customer insights to a company relative to previous methods.

In some embodiments, the system 100 may performs a binary problem assessment. That is, when presenting a problem inventory (or list of problem statements) to a respondent, the system 100 might only ask for the respondent to indicate whether the problem happened or did not happen. As noted above, problem statements generated by problem statement generation system 902 may be automatically generated in a format which requires a respondent to only indicate “yes” or “no” in response. The benefits of this approach may include, for example:
Elimination of “scale bias” error from responses;
A more accurate representation of problem frequency in the customer base;
Lower cognitive effort for the respondent;
Creation of a highly structured data set with only two primary states (yes/no) for each problem.

In some embodiments, the system 100 may de-couple problem occurrence from problem importance. In such embodiments, the system 100 does not rely on the respondent's assessment of problems (beyond the simple presence or absence of the problem) to evaluate the problem's economic impact. Stated differently, in some embodiments, system 100 does not ask customer to “score” or rank problems according to degree of pain or inconvenience arising from the problem. Instead, the system 100 utilizes the “presence/absence” scores of each problem across all customer respondents as a sample set for CART and tabular analysis. This analysis may facilitate isolating the problems that matter the most to customer economic value, and quantifying the degree to which they are most material. Some embodiments may also determine the relationship between each problem experience and the dependent variable (“DV”, also referred to herein as ‘variables’) selected to represent customer economic value (which may vary among different analyses). The merits of this approach may include, for example:
Replacement of self-evaluated problem-importance data with derived problem-importance data, which may improve statistical reliability and lower error and bias in the data set;
Elimination of the “top-of-mind” effect, thereby lowering error and bias in the data set;
Lower cognitive effort required from the respondent.

In some embodiments, the system 100 is configured to perform an analysis that determines the statistical relationship between the occurrence of specific customer problem experiences for a given company and that company's market performance as measured by revenue and market share. In some embodiments, system 100 is configured to isolate the problems that matter to customer economic value, quantify the degree to which each problem matters, and determining the relationship between each problem experience and the dependent variable(s) selected to represent customer economic value. In some embodiments, the specificity of this mapping is a key component of actionability for system 100.

In some embodiments, the process carried out by the system 100 may be multi-staged, and may include, in some embodiments: 1) problem selection analysis, 2) data set creation, and 3) problem resolution analysis, as further described in detail below. For example, problem selection analysis is performed to determine which problems matter to customer economic value. In some embodiments, the system 100 can be configured to carry out a CART decision tree analysis to determine, out of all the problem statements presented in a quantitative survey (generally between 60 and 80 individual statements, see e.g., FIGS. 8A to 8G), which problems are the most influential or impactful problems on customer economic value. The CART decision tree analysis may include the following steps.

In the problem selection analysis step, a dependent variable (DV) can be selected to represent customer economic value. This DV can be either categorical (e.g. “Promoter/Detractor” or “Highly Likely to Trial/Not Likely to Trial) or continuous (e.g. customer revenue, number of products purchased, number of store visits, and so on). In the data set creation step, a data set is created that associates the presence or absence of every problem interrogated in the survey against the DV in question, for all survey respondents.

In the problem resolution analysis step, the presence or absence of a specific problem for a specific respondent is assessed against the associated DV value of that respondent. This may establish a “relationship data point” (RDP) between that particular instance of the problem and the DV value. This RDP may then be compared to a second RDP created in the same way, using a different problem-DV paring.

In some embodiments, the analysis may continue to evaluate problem-DV parings in all relevant combinations, both within and across customers, cycling through millions of different pairings. These iterative pairings, and the underlying algorithms that interpret them, may create a tree diagram or structure in which each internal node in the tree represents a specific problem from the list or portfolio of problems. Respondents can either “have” or “not have” the problem, and the tree may “branch” accordingly, thereby partitioning the full data set into successively smaller groups.

Next, the CART analysis may generate a binary tree that identifies and orders the problems for each node that best maximizes the homogeneity of the resulting groups at the end of each branch (e.g., leaf nodes), those groups being respondents exhibiting superior or inferior economic value as represented by the DV.

The end result of problem selection analysis is a list of problems that most accurately predict whether a customer will exhibit economic value decline. These problems are referred to as the “Most Damaging Problems” (MDPs) of the analysis. With this list of MDPs, the problem selection analysis can be carried out by the system 100, which quantifies the relative impact of each problem on the DV in question.

Problem impact analysis is carried out to determine how damaging each MDP is to customer economic value. The system 100 can be configured to calculate the total damage impact of each MDP to customer by assessing two distinct dimensions of damage for each MDP: MDP frequency and absolute impact of the MDP.

The more frequently an MDP occurs within the customer base, the more opportunity the MDP has to damage customer equity and reduce customer economic value. Frequency can be directly calculated based on survey responses as the number of customers reporting having had the problem divided by the total number of customers surveyed. For example, out of 650 customers surveyed, if 228 reported experiencing “MDP X”, MDP X would have a frequency of 35%.

The second dimension is the absolute impact of the MDP. This is a measure of the damage to customer economic value when a customer experiences the problem, compared to the economic value of a customer who does not experience the problem. In some embodiments, the general process for calculating absolute problem impact of a specific MDP may include:
1. Dividing the total sample set of customers in the survey into two classes: those who experienced MDP X (“YES” group), and those who did not experience MDP X (“NO” group). Note that “MDP X” can represent any MDP identified in the problem selection analysis step.
2. Dividing each YES and NO customer class into discrete sub-groups that represent their relative economic value, as proxied by the DV used for the analysis. Categorical DVs that assign customers into a priori value tiers establish these sub-groups directly. For example: Promoters vs. Passives vs. Detractors (in the NPS measurement framework), or customers Highly Likely to Trial vs. customers Not Likely to Trial. Continuous DVs, such as spend or number of products purchased, may require threshold determination to classify customers into discrete value tiers.
3. Once each YES and NO class is divided into discrete sub-groups that represent their relative economic value, selecting a single economic value sub-grouping for YES/NO comparison. For example: YES Detractors (who had MDP X) vs. NO Detractors (who did not have MDP X).
4. Calculating the percentage of customers falling into each sub group according to YES/NO status for the particular problem in question. For example: 57% of YES customers (who had MDP X) are Detractors, vs. 23% of NO customers (who did not have MDP X) are Detractors.
5. Calculating the impact of YES/NO status—i.e. the presence/absence of MDP X-on the economic sub-group, using class-comparative calculation. For example, 57% of YES customers (who had MDP X) are Detractors, vs. 23% of NO customers (who did not have MDP X) are Detractors. So when MDP X happens, it increases the likelihood of Detractorship (which represents damage to customer economic value) by 149%: (57%÷23%)−23%=149%.
6. Converting the impact of problem presence/absence into customer economic value. This can be implemented in several ways. For example, when using DVs that proxy for economic value, the system 100 can use the economic proxy data to calculate economic damage from the problem. For example, if on average Detractors spend $100 less per annum than non-Detractors, and MDP X increases the likelihood of Detractorship by 149%, the imputed economic damage to a particular customer's spend when MDP X happens to that customer is an incremental $149. When using DVs that directly represent economic value (such as spending), the economic impact calculation can be calculated directly. Example: if YES customers (who had MDP X) spend on average $350/annum, and NO customers (who did not have MDP X) spend on average $480/annum, the impact of MDP X on per-customer annual spend is $130. Note that in circumstances where the analytic DV is a direct representation of customer economic value, The analysis can skip the Step 5 class-comparative calculations and DV proxy conversions.

With MDP frequency and absolute impact of the MDP calculated for a specific MDP, the final step in quantifying the economic impact of the MDP is to multiply both values to generate a single, weighted average overall economic impact value of the MDP across the full customer set. This value can be compared against other MDP scores for business prioritization: those MDPs that represent the greatest risk of economic damage to the customer base are those that represent the highest return on investment if the MDPs can be eliminated, reduced or mitigated. For example: out of 650 customers surveyed, 228 reported experiencing “MDP X”. MDP X has a frequency of 35%. When MDP X occurs, it damages annual customer spend by $149, which is also referred to as the “revenue at risk” value. The total customer base in this example is 22,000 customers. The total economic risk value of MDP X is approximately $1,150,000.

Problem resolution analysis can be undertaken to determine how to address an MDP so as to mitigate damage to customer economic value. In addition to the MDP identification and quantification analyses described above, the system 100 can also conduct analysis on the efficacy and economic impact of a company's problem resolution processes. This analysis can explain how effective these processes are in mitigating damage to customer value due to problem experiences, and provide a company with a roadmap for handling problems when they occur.

The problem resolution analysis may include, for example, after survey respondents have reviewed the problem inventory and identified which problems from the inventory they personally experienced, they each select one problem they deem “most important.” In some embodiments, this selected problem can be the problem that will be assessed in the problem resolution analysis. Note that the “most important problem” according to a customer's subjective experience may be different from a “Most Damaging Problem” (or MDP). Most important problems are self-identified by respondents, not analytically derived, and are only used as a problem resolution case examples to determine problem resolution impact on customer economic value.

For each problem resolution case example, a respondent can provide detail on a range of descriptive attributes describing the problem resolution experience. In some embodiments, for an analysis by the system 100, three attributes may be considered:
Time: how long it took for the problem to be addressed;
Effort: how much effort (e.g., contact attempts made by the respondent) it took for the problem to be addressed;
Efficacy: how satisfied the respondent was overall with the problem resolution experience provided to them.

The attributes of time, effort and efficacy may then be cross-referenced against the DV representing customer economic value to show how customer economic value changes as the attributes change. The analysis typically shows the following:
Time. The longer it takes to resolve a problem, the greater the residual damage to the customer economic value originally lost due to the problem. Conversely, the shorter the time to resolve, the greater the “recovery” of the economic value originally lost due to the problem. Time-to-resolve analysis quantifies the extent of this loss or recovery, and establishes the primary time-to-resolve thresholds at which loss accelerates.
Effort. The more effort it takes for a customer to resolve a problem, the greater the residual damage to the customer economic value originally lost due to the problem. Conversely, the less effort exerted to resolve, the greater the “recovery” of the economic value originally lost due to the problem. Effort-to-resolve analysis quantifies the extent of this loss or recovery, and establishes the primary effort thresholds at which loss accelerates.
Efficacy. Overall, the more satisfied a customer is with the problem resolution provided to them, the lower the residual damage to the customer economic value originally lost due to the problem. Conversely, the less satisfied a customer is with problem resolution, the greater the residual damage to the customer economic value originally lost due to the problem. Efficacy analysis quantifies the extent of this loss or recovery across four a priori thresholds:
   Complete satisfaction with problem resolution;
   Acceptable satisfaction with problem resolution;
   Non-acceptable satisfaction with problem resolution;
   No problem resolution occurred.

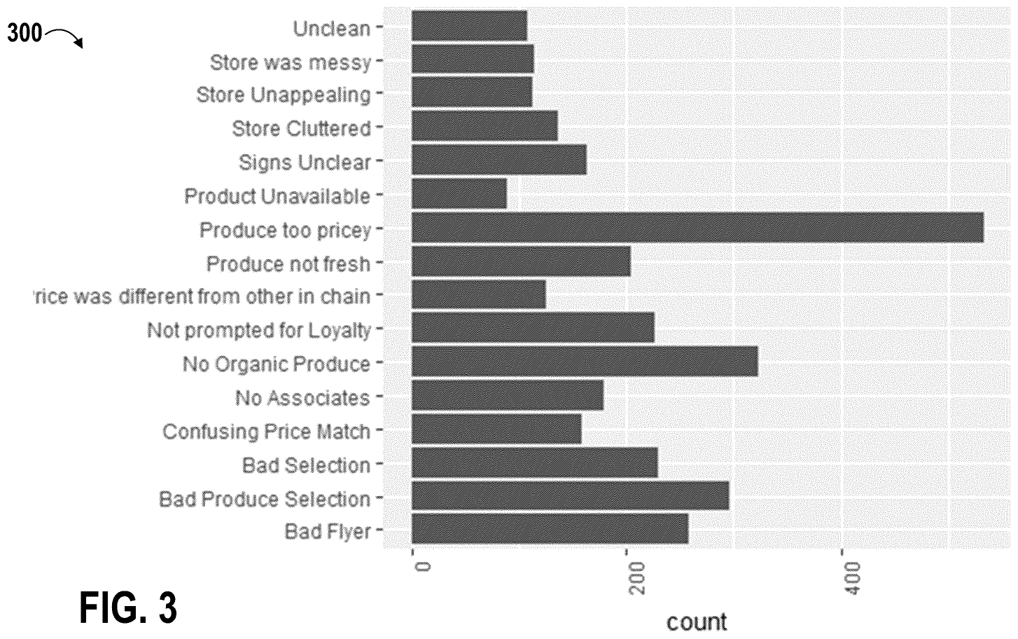

FIG. 3 shows an example list 300 of potential negative experiences customers can encounter at a physical grocery store, each mapped to a corresponding number of occurrences, based on a set of example feedback data 150 obtained from a group of customers. The example list 300 includes problems such as unclean store, messy store, unappealing store, cluttered store, unclear signs, unavailable product, produce is too pricey, produce is not fresh, rice was different from another store in the same chain, not prompted for loyalty card, no organic produces, no associates to help, confusing price match policy, bad selection of products, bad selection of produces, and bad flyer. Some problems may be experienced in tandem (e.g, produce not being fresh rarely occurs in isolation, which makes modelling it challenging even if it frequently occurs). For example, the problem of produce not being fresh may have 205 occurrences or counts, but may have a positive coefficient, indicating a positive impact on a customer's spending habits. Such a problem can be filtered by the analysis undertaken by the system 100, as described above.

Once the impact to share of wallet is determined for each problem, the economic impact (e.g., “customer would have spent $300 more if this problem were not experienced”) can be calculated. The customer's monthly spending can be calculated from their stated share and stated spending level at that grocer, based on the feedback data 150. Then, the spending or revenue at risk from that problem can be calculated from the model coefficient as follows, shown in table 1 below.

TABLE 1

| | | | | | Monthly | |
|---|---|---|---|---|---|---|
| | | | | | Spending, | Impacted |
| | | | Share | Monthly | across all | Spending |
| | Problem | Model | of | Spending | Grocery | from |
| Customer | Experienced | Coefficient | Wallet | at Grocer X | Stores | Problem ($) |
| A | Not Prompted for | 7% | 33% | $ 100.00 | $ 300.00 | 21.00 |
| | Loyalty | | | | | |
| A | NoOrganic | 3% | 33% | $ 100.00 | $ 300.00 | 9.00 |
| | Produce | | | | | |
| A | Store Cluttered | 15% | 33% | $ 100.00 | $ 300.00 | 45.00 |
| B | Not Prompted for | 7% | 50% | $ 100.00 | $ 200.00 | 14.00 |
| | Loyalty | | | | | |
| C | Bad flyer | 5% | 10% | $ 100.00 | $ 1,000.00 | 50.00 |

FIG. 4 is an example graphical user interface (GUI) 400 displaying an example average revenue at risk per customer based on the feedback fata 150 gathered by the system 100. As shown, an average annual revenue at risk per customer value 410 is shown to be $−61, which means that a customer is likely to send $61 less, on average, based on a plurality of problems identified in area 425 of the GUI. The average annual revenue at risk per customer value is also part of a trend graph 415. Out of the problems identified in 425, the top problem 418 is limited home appliance selection, with the highest revenue at risk of $−15. Area 420 of the GUI 400 displays the corresponding revenue at risk value for each of the problem identified in area 425. A separate area 430 shows a category of each problem identified in area 425.

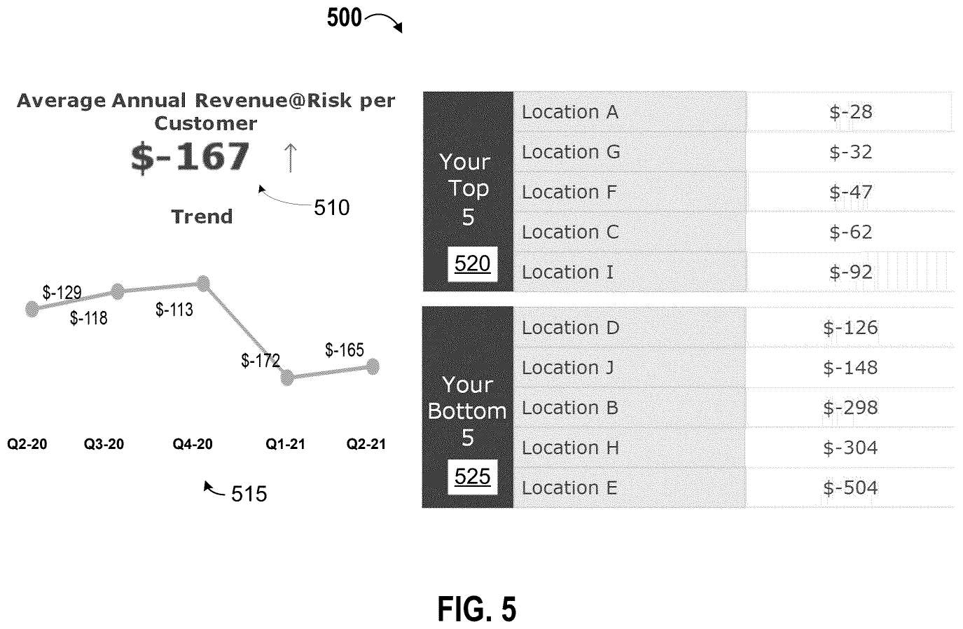

FIG. 5 is an example graphical user interface (GUI) 500 displaying an average annual revenue at risk per customer and a list of locations with the highest risk or lowest risk. The average annual revenue at risk per customer 510 in this case is shown to be $−167. The trend plot 515 spans from the second quarter of 2020 to the second quarter of 2021, for example. The period may be modified based on user requirements or selection. In addition, GUI 500 shows the top 5 locations 520 in a physical store experiencing the lowest amount of revenue at risk per customer. Similarly, GUI 500 shows the bottom 5 locations 525 in a physical store experiencing the highest amount of revenue at risk per customer.

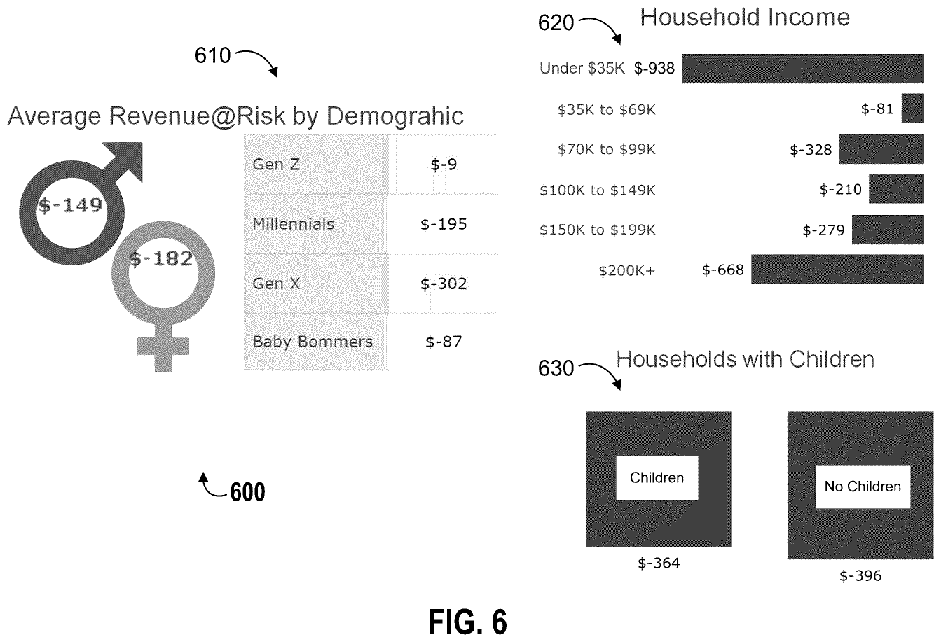

FIG. 6 is an example graphical user interface (GUI) 600 displaying an example average revenue at risk per customer grouped by demographic and household income. Area 610 shows an average revenue at risk by demographic, including gender and generations. Area 620 shows an average revenue at risk by household income, ranging from under $35,000 income to over $200,000 income. Area 630 shows an average revenue at risk by households with or without children.

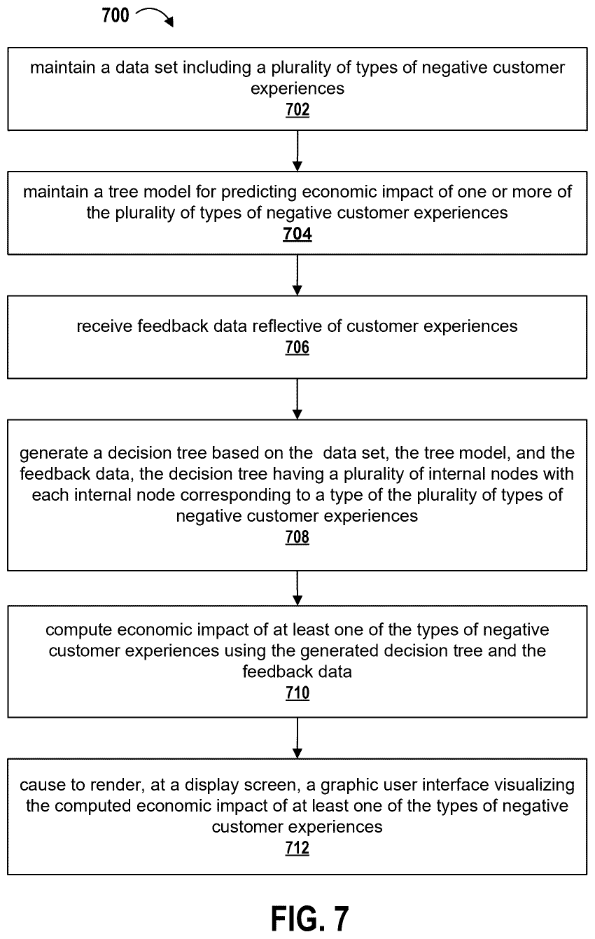

FIG. 7 shows an example process 700 for computing economic impact of customer experiences performed by the system 100 in FIG. 1, exemplary of embodiments. The method 700 may include, at block 702, the system 100 stores and maintains, in database 122, a data set including a plurality of types of negative customer experiences. For example, the data set may include a portfolio of hundreds of experiences 220 for customers 210, who encounter these experiences in the course of their relationship with a company 230, at their physical store locations.

At block 704, the system 100 maintains a tree model 110 for predicting economic impact of one or more of the plurality of types of negative customer experiences. In some embodiments, the tree model 110 is a classification and regression tree (CART) model and the decision tree is a binary tree.

At block 706, the system 100 receives feedback data 150 reflective of customer experiences. FIGS. 8A to 8G show an example survey that can be given to by one or more customers for completion. For example, the survey can be electronically presented to the one or more customers at their display devices 130 via an e-mail link. The answers from the survey completed by the customers may be processed and stored as the feedback data 150.

At block 708, the system 100 generates a decision tree 112 based on the tree model 110, the data set and the feedback data 150, the decision tree having a plurality of internal nodes with each internal node corresponding to a type of the plurality of types of negative customer experiences. The tree model 110 may be used to generate the decision tree for computing the economic impact of the customer experiences based on feedback data 150 received via network 140. The decision tree may include a plurality of internal nodes with each internal node corresponding to a type of the plurality of types of negative customer experiences. An internal node may refer to a node that has child node(s).

In some embodiments, each leaf (or leaf node) of the decision tree may include a class label indicating a classification of a type of negative customer experience corresponding to a given internal node of the decision tree, which may be the parent node of the leaf. For example, the class label may has a real value between 0 and 1, where a value equal to or greater than 0.5 indicates that the associated type of negative customer experience has a meaningful economical impact. A meaningful economical impact may indicate that the type of negative customer experience has resulted in a economical loss above a certain threshold during a period, e.g., $1,000 per week.

In some embodiments, generating the binary tree 112 may be done through machine learning using a predictive modeling. An example decision tree algorithm is classification and regression trees (CART). Using the CART algorithm, the training engine 116 may be configured to generate binary tree by selecting input variables and split points on those variables until a suitable tree is constructed. The selection of which input variable to use and the specific split can be implemented using a greedy algorithm to minimize a cost function. Typically, construction of the binary tree ends based on a predefined stopping criterion, such as a minimum number of training instances assigned to each leaf node of the tree.

In some embodiments, the binary tree 112 may be generated by: splitting a data set representing a plurality of types of negative customer experiences into two groups based on a first cost function; and for each of the two groups: splitting the types of negative customer experiences in each respective group into two subsets based on a second cost function; and iteratively splitting the types of negative customer experiences in each respective subset into further binary subsets using a recursive binary splitting procedure until a predetermined threshold is reached. The predetermined threshold can be, for instance, a count on a total number of training instances assigned to each internal node of the binary tree.

In some embodiments, splitting the types of negative customer experiences includes selecting one type from the types of negative customer experiences and setting the selected type as an internal node.

At block 710, the system 100 computes economic impact of at least one of the types of negative customer experiences using the generated decision tree and the feedback data 150. In some embodiments, computing the economic impact of at least one of the types of negative customer experiences may include: computing, for the at least one type of negative customer experience, a frequency of occurrence among a plurality of customers based on the feedback data; computing, for the at least one type of negative customer experience, a financial impact on the plurality of customers based on the feedback data; and determining the economic impact of for the at least one type of negative customer experience by multiplying the frequency of occurrence by the financial impact.

In some embodiments, computing the financial impact for the at least one type of negative customer experience on the plurality of customers based on the feedback data may include: determining, based on the feedback data, a first average amount of spending among a first group of customers that did not experience the at least one type of negative customer experience, the first group of customers from the plurality of customers; determining, based on the feedback data, a second average amount of spending among a second group of customers that experienced the at least one type of negative customer experience, the second group of customers from the plurality of customers; and computing the financial impact based on a difference between the first average amount of spending and the second average amount of spending.

At block 712, the system 100 causes to render, at a display screen of a display device 130, a graphic user interface visualizing the computed economic impact of at least one of the types of negative customer experiences. Example GUI data elements are shown in FIGS. 4, 5 and 6.

In some embodiments, the CART analysis may be augmented with other machine-learning capabilities to identify additional high-impact relationships between data elements that will inform a more robust and actionable experience-to-value model for clients. These relationships may include, for example:
a. How customer experiences influence a range of customer economic value markers concurrently (e.g. spend, spend velocity, trial propensity, product penetration, share allocation, service costs, etc.), and how these value markers interact between themselves to deliver a desired “meta-optima” that projects the future customer economic potential more accurately than any single value marker.
b. The customer characteristics that influence how experiences impact customer value. These would include demographic and psychographic characteristics, as well as other behavioral characteristics not comprehended by spend/value behaviors: channel proclivities, information seeking habits, usage/ownership behaviors, depth of relationship with company agents, etc.
c. The circumstances of experience creation that influence how experiences impact customer value. These could be any situational data point relevant to a “problem experience use case”, including channel, product, time/seasonality, go-to-market model (e.g. direct vs. retail intermediated), etc.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, systems, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for analyzing unstructured data representative of customer experiences, the system comprising:
at least one processor;
a non-transitory computer-readable medium having stored thereon processor-executable instructions that, when executed by said at least one processor, cause the at least one processor to perform a method comprising:
maintaining a historical problem statement data set including a plurality of text strings identifying problem statements associated with customer experiences;
obtaining an input data set comprising unstructured data representative of customer experiences; and
generating, based on a large language model (LLM) and said historical problem statement data set, an output data set comprising one or more generated problem statements.

2. The system of claim 1, wherein generating said output data set comprises using retrieval-augmented generation (RAG) techniques.

3. The system of claim 1, wherein said input data comprises a plurality of text data transcripts.

4. The system of claim 1, wherein said output data set comprises, for each of said one or more generated problem statements, at least one of an associated category, domain and nature.

5. The system of claim 1, wherein said output data set is embodied as a spreadsheet.

6. The system of claim 1, wherein said output data set comprises, for each of said one or more generated problem statements, a severity attribute.

7. The system of claim 1, wherein said method further comprises selecting a subset of said generated problem statements for inclusion in a survey.

8. The system of claim 1, wherein said output data comprises, for each of said one or more generated problem statements, an attribute indicating whether said respective problem statement has been previously identified as a most damaging problem.

9. The system of claim 7, wherein said selecting said subset of said generated problem statements is based on at least one associated attribute of said generated problem statements.

10. The system of claim 1, wherein said method further comprises updating said historical problem statement data said to include one or more of said generated problem statements.

11. The system of claim 1, wherein said output data includes, for each of said generated problem statements, an indication of the passage in the input data which was the basis for the respective generated problem statement.

12. A computer-implemented method for analyzing unstructured data representative of customer experiences, the method comprising:
maintaining a historical problem statement data set including a plurality of text strings identifying problem statements associated with customer experiences;
obtaining an input data set comprising unstructured data representative of customer experiences; and
generating, based on a large language model (LLM) and said historical problem statement data set, an output data set comprising one or more generated problem statements.

13. A non-transitory computer-readable medium having stored thereon computer-readable instructions that, when executed by one or more processors, cause the one or more processors to perform a method comprising:
maintaining a historical problem statement data set including a plurality of text strings identifying problem statements associated with customer experiences;
obtaining an input data set comprising unstructured data representative of customer experiences; and
generating, based on a large language model (LLM) and said historical problem statement data set, an output data set comprising one or more generated problem statements.
